(19) United States
(12) Patent Application Publication
(10) Pub. No.: US 2023/0213255 A1
(43) Pub. Date: Jul. 6, 2023

(54) REFRIGERATION SYSTEM WITH TANDEM HIGH-SIDE COMPRESSORS

(71) Applicant: Carrier Corporation, Palm Beach Gardens, FL (US)

(72) Inventors: Matthew Clark, Rochester, NY (US); Ahmad M. Mahmoud, Windsor, CT (US); Alexander Healey, Syracuse, NY (US); Jun Pyo Lee, Zionsville, IN (US)

(21) Appl. No.: 18/149,944

(22) Filed: Jan. 4, 2023

Related U.S. Application Data
(60) Provisional application No. 63/296,369, filed on Jan. 4, 2022.

(51) Int. Cl. F25B 49/02; F25B 31/00

(52) U.S. Cl. CPC F25B 49/022; F25B 31/002; F25B 31/02

(57) ABSTRACT

A refrigeration system is provided and includes a common suction line, a common discharge line, first and second high-side compressors disposed in parallel to receive low-pressure refrigerant from the common suction line and to direct high-pressure refrigerant to the common discharge line, a first pipe connected to the first and second high-side compressors at vertical heights at which an oil supply is required to remain higher and a second pipe connected to the first and second high-side compressors at vertical heights sufficient to maintain gas pressure balance between the first and second high-side compressors.

### CROSS-REFERENCE TO RELATED APPLICATIONS

This application claims priority to U.S. Provisional Application Ser. No. 63/296,369, filed Jan. 4, 2022, the contents of which are hereby incorporated by reference in its entirety.

### BACKGROUND

The following description relates to heating, ventilation, and air conditioning (HVAC) systems and, more specifically, to an HVAC system with tandem high-side compressors.

An HVAC system typically makes use of a vapor-compression cycle to condition a defined space, for air conditioning and heat pump systems. A compressor compresses refrigerant vapor and outputs high-temperature and high-pressure refrigerant vapor to a condenser. Within the condenser the high-temperature and high-pressure refrigerant vapor is condensed into liquid refrigerant, which is output to an expansion valve that generates a mixture of liquid refrigerant and refrigerant vapor. This mixture is passed to the evaporator, where the mixture removes heat from a flow of warm or heated air passing over the evaporator. The refrigerant is then passed from the evaporator back to the compressor, completing the cycle.

With the increasing need for higher-efficiency HVAC systems, the use of variable speed compression is becoming increasingly common. Today, most high-efficiency HVAC systems utilize one large variable speed compressor. However, the cost of this large variable speed compressor is relatively high as compared to fixed speed compressors commonly used in less efficient HVAC systems.

### BRIEF DESCRIPTION

According to an aspect of the disclosure, a refrigeration system is provided and includes a common suction line, a common discharge line, first and second high-side compressors disposed in parallel to receive low-pressure refrigerant from the common suction line and to direct high-pressure refrigerant to the common discharge line, a first pipe connected to the first and second high-side compressors at vertical heights at which an oil supply is required to remain higher and a second pipe connected to the first and second high-side compressors at vertical heights sufficient to maintain gas pressure balance between the first and second high-side compressors.

In accordance with additional or alternative embodiments, the refrigeration system further includes an evaporator from which the common suction line carries the low-pressure refrigerant, a condenser to which the common discharge line carries the high-pressure refrigerant and an expansion valve fluidly interposed between the condenser and the evaporator.

In accordance with additional or alternative embodiments, the first pipe includes a valve and the second pipe includes a valve.

In accordance with additional or alternative embodiments, each of the first and second high-side compressors includes a shell to define an interior, a compressor section disposed within the interior to compress the low-pressure refrigerant and a motor disposed within the interior at a location, which is closer to the common discharge line than the common suction line, to drive operations of the compressor section.

In accordance with additional or alternative embodiments, the first pipe allows oil to pass between the shell of each of the first and second high-side compressors.

In accordance with additional or alternative embodiments, the motor includes a stator and the shell defines a flow path by which gas flows about the stator for each of the first and second high-side compressors.

In accordance with additional or alternative embodiments, the second pipe is connected to the shell of each of the first and second high-side compressors above the motor and opposite the flow path.

In accordance with additional or alternative embodiments, the second pipe is positioned to minimize a shell pressure difference between the first and second high-side compressors.

According to an aspect of the disclosure, a refrigeration system is provided and includes a common suction line, a common discharge line and first and second high-side compressors disposed in parallel to receive low-pressure refrigerant from the common suction line and to direct high-pressure refrigerant to the common discharge line. The first high-side compressor includes a fixed speed compressor and the second high-side compressor includes a variable speed compressor.

In accordance with additional or alternative embodiments, the refrigeration system further includes an evaporator from which the common suction line carries the low-pressure refrigerant, a condenser to which the common discharge line carries the high-pressure refrigerant and an expansion valve fluidly interposed between the condenser and the evaporator.

In accordance with additional or alternative embodiments, the variable speed compressor has a capacity of a percentage of a total refrigeration system capacity requirement and the fixed speed compressor has a capacity of a remainder of the total refrigeration system capacity requirement.

In accordance with additional or alternative embodiments, each of the first and second high-side compressors includes a shell to define an interior, a compressor section disposed within the interior to compress the low-pressure refrigerant and a motor disposed within the interior at a location, which is closer to the common discharge line than the common suction line, to drive operations of the compressor section.

In accordance with additional or alternative embodiments, the refrigeration further includes a first pipe connected to the first and second high-side compressors at vertical heights at which an oil supply is required to remain higher and a second pipe connected to the first and second high-side compressors at vertical heights sufficient to maintain gas pressure balance between the first and second high-side compressors.

In accordance with additional or alternative embodiments, the first pipe includes a valve and the second pipe includes a valve.

In accordance with additional or alternative embodiments, the first pipe allows oil to pass between a shell of each of the first and second high-side compressors.

In accordance with additional or alternative embodiments, a motor drives a compressor section and comprises a stator and a shell defines a flow path by which gas flows about the stator for each of the first and second high-side compressors.

In accordance with additional or alternative embodiments, the second pipe is connected to the shell of each of the first and second high-side compressors above the motor and opposite the flow path.

In accordance with additional or alternative embodiments, the second pipe is positioned to minimize a shell pressure difference between the first and second high-side compressors.

According to an aspect of the disclosure, a method of operating a refrigeration system is provided and includes operating first and second high-side compressors in parallel to receive low-pressure refrigerant from the common suction line and to direct high-pressure refrigerant to the common discharge line, maintaining an oil level within a shell of each of the first and second high-side compressors above respective oil equalization line connection heights and maintaining a gas balance between the first and second high-side compressors via a gas equalization line connected to the respective shells above respective motors thereof and opposite respective flow paths by which gas flows about respective stators of the respective motors.

In accordance with additional or alternative embodiments, the first high-side compressor comprises a fixed speed compressor and the second high-side compressor comprises a variable speed compressor, the variable speed compressor has a capacity of a percentage of a total refrigeration system capacity requirement and the fixed speed compressor has a capacity of a remainder of the total refrigeration system capacity requirement.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features and advantages of the disclosure are apparent from the following detailed description taken in conjunction with the accompanying drawings in which:

FIG. 1 is a cross-sectional side view of exemplary twin BLDC rotary compressors in accordance with embodiments;

FIG. 2 is a schematic diagram illustrating an exemplary result of a gas pressure imbalance on the twin BLDC rotary compressors of FIG. 1 in accordance with embodiments;

FIG. 3 is a side view of exemplary first and second high-side compressors disposed in tandem in accordance with embodiments;

FIG. 4 is a side view of exemplary first and second high-side compressors disposed in tandem in accordance with embodiments;

FIG. 5 is a schematic diagram of an exemplary refrigeration system including the first and second high-side compressors of FIG. 3 in accordance with embodiments;

FIG. 6 is a schematic diagram of an exemplary refrigeration system including first and second high-side compressors of which one is a fixed speed compressor and the other is a variable speed compressor in accordance with embodiments; and

FIG. 7 is a flow diagram illustrating an exemplary method of operating a refrigeration system in accordance with embodiments.

These and other advantages and features will become more apparent from the following description taken in conjunction with the drawings.

### DETAILED DESCRIPTION

As will be described below, an HVAC system is provided in which two, relatively inexpensive compressors are used to achieve a same operating range as a single, relatively expensive variable speed compressor. The two, relatively inexpensive compressors include one fixed-speed (FS) compressor in tandem (i.e., parallel) with a variable speed (VS) compressor.

A sizing of the FS and VS compressors can be selected such that, at design conditions, a most efficient compressor or combination of compressors is used. For example, at lower capacities, the VS compressor is used due to its larger and more efficient operation as well as it's speed range and envelope. As another example, at high load conditions, both the FS and VS compressors are operated to deliver required capacity. In any case, the compressors can both be sized to operate at high ambient cooling and low ambient heating conditions, though it is to be understood that compressor tandem sizing and operation is a function of the performance, cost and packaging constraints for specific use cases.

In some cases, the variable speed compressor covers a portion of the capacity range (e.g., about 25-45%) and the FS compressor provides the remaining capacity (55-75%), although it is to be understood that various capacity ranges and combinations are possible. In any case, in combination, the fixed speed compressor and the variable speed compressor can provide an operating range from 1-100% of capacity of the full capacity range of a single relatively expensive variable speed compressor. If selected properly, this combination may result in cost savings and performance improvements.

The FS and VS compressors can be termed as high-side compressors and special piping and components are provided to keep shell pressures close to equal to prevent oil pump out, for oil balance and management between the tandem compressors and to provide for oil return from a system.

In general, hermetic and semi-hermetic HVAC compressors can be classified as either high-side or low-side compressors. This terminology refers to the location of the compressor motor within the compressor shell. If the compressor motor is positioned before the compression chamber (i.e., on the low-pressure side, in contact with suction gas from the evaporator), it is referred to as a low-side compressor. If the compressor motor is positioned after the compression chamber (i.e., on the high-pressure side, in contact with discharge gas leaving to the condenser), it is referred to as a high-side compressor.

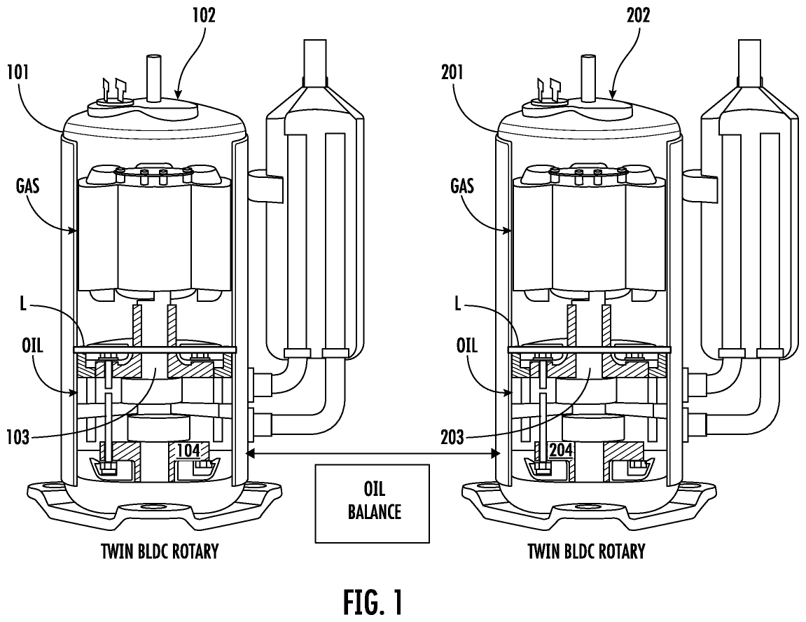

With reference to FIG. 1, shells 101 and 201 of compressors 102 and 202 accommodate oil and refrigerant gas. In high-side compressors, the gas in the shells 101 and 201 has left the compression chamber and is at an elevated pressure. In a tandem compressor assembly, the oil level in each compressor 102 and 202 must be high enough to lubricate rotating components 103 and 203. This is illustrated by the line L shown in each of the compressors 102 and 202. While operating, some of the oil is carried from the compressors 102 and 202 and into the system being conditioned. Refrigerant carries this oil back to compressors 102 and 202, but it will not necessarily return the oil evenly, especially if the mass flow through compressors 102 and 202 is the not the same.

Such imbalanced oil return requires that the system be able to balance oil between the sumps 104 and 204 of each of the compressors 102 and 202. This can be a challenge because the gas pressure in the shells 101 and 201 above the oil is not necessarily the same. When the gas pressure is not the same, the compressor at a higher pressure will push oil into the compressor at a lower pressure, causing the oil levels to be different.

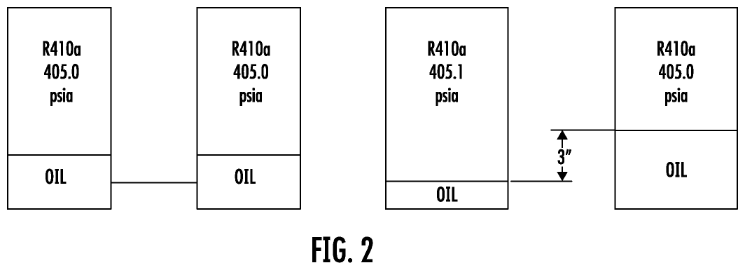

In an exemplary case, as shown in FIG. 2, a compressor with a higher gas pressure will push oil into the other compressor in a tandem compressor system. As such, gas pressure in each shell 101 and 201 must be nearly exactly balanced to allow differences in oil height to rebalance oil between the shells 101 and 201 and to thereby maintain a same oil level in both compressors.

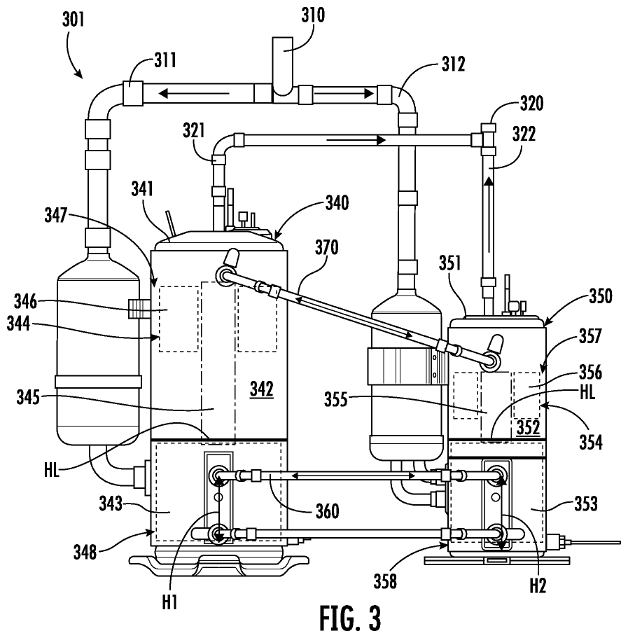

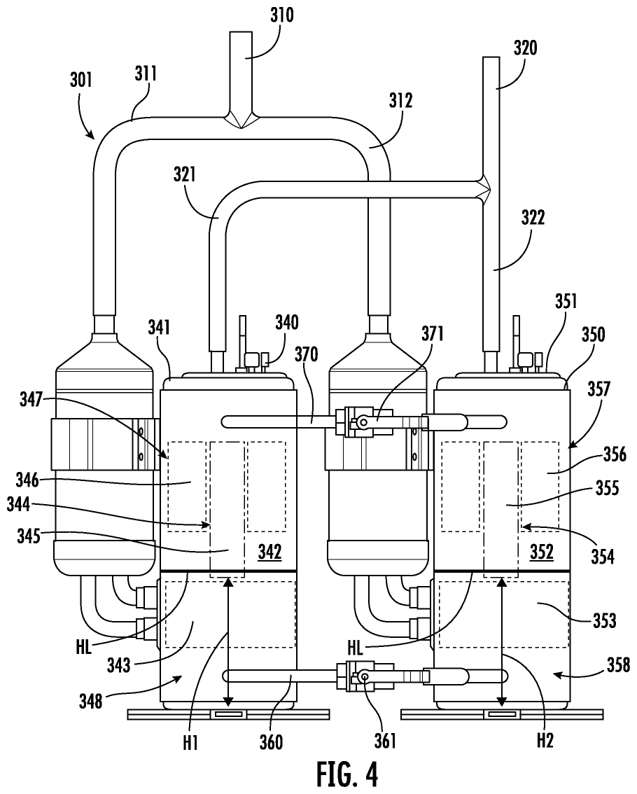

With reference to FIGS. 3 and 4, a refrigeration system 301 is provided and includes a common suction line 310, including a first leg 311 and a second leg 312, a common discharge line 320, including a first leg 321 and a second leg 322, a first high-side compressor 340, a second high-side compressor 350, a first pipe 360 and a second pipe 370 (angled in FIG. 3 and horizontal in FIG. 4). The first and second high-side compressors 340 and 350 are disposed in parallel with one another to receive low-pressure refrigerant from the first and second legs 311 and 312 of the common suction line 310, respectively, and to direct high-pressure refrigerant to the first and second legs 321 and 322 of the common discharge line 320.

The first high-side compressor 340 includes a shell 341 to define an interior 342, a compressor section 343 that is disposed within a lower portion of the interior 342 to compress low-pressure refrigerant (received from an evaporator as will be described below) and a motor 344. The motor 344 is configured to drive operations of the compressor section 343 and includes a rotor 345 that is caused to rotate by a stator 346 that surrounds the rotor 345. As a high-side compressor, the motor 344 is disposed within an upper portion of the interior 342 at a location in contact with gas that has already left the compression chamber 343. The shell 341 is formed to define a flow path 347 for discharge gas to flow around the stator 346. The shell 341 is also formed to define an oil sump 348 in the lower portion of the interior 342. In FIGS. 3 and 4, an upper level of oil in the oil sump 348 is illustrated by the horizontal line HL.

The second high-side compressor 350 includes a shell 351 to define an interior 352, a compressor section 353 that is disposed within a lower portion of the interior 352 to compress low-pressure refrigerant (received from an evaporator as will be described below) and a motor 354. The motor 354 is configured to drive operations of the compressor section 353 and includes a rotor 355 that is caused to rotate by a stator 356 that surrounds the rotor 355. As a high-side compressor, the motor 354 is disposed within an upper portion of the interior 352 at a location in contact with gas that has already left the compression chamber 343. The shell 351 is formed to define a flow path 357 for discharge gas to flow around the stator 356. The shell 351 is also formed to define an oil sump 358 in the lower portion of the interior 352. In FIGS. 3 and 4, an upper level of oil in the oil sump 358 is illustrated by the horizontal line HL.

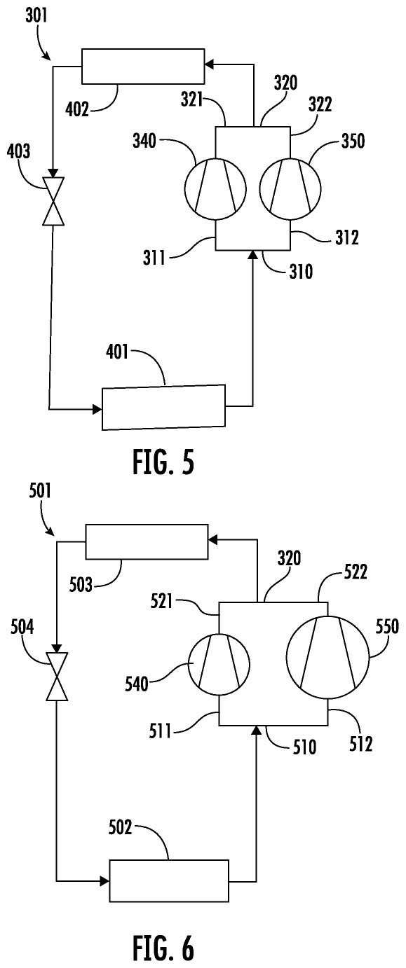

With reference to FIG. 5, the refrigeration system 301 can further include an evaporator 401 from which the common suction line 310 carries the low-pressure refrigerant to the first and second high-side compressors 340 and 350, a condenser 402, which is receptive of the high-pressure refrigerant from the first and second high-side compressors 340 and 350 by way of the common discharge line 320, and an expansion valve 403 that is fluidly interposed between the condenser 402 and the evaporator 401. With these or other configurations, the refrigeration system 301 has a total refrigeration system capacity requirement and the first high-side compressor 340 provides a portion of the total refrigeration system capacity requirement while the second high-side compressor 350 provides the other portion of the total refrigeration system capacity requirement.

In accordance with embodiments, the first high-side compressor 340 can include or be provided as a fixed speed compressor and the second high-side compressor 350 can include or be provided as a variable speed compressor. In accordance with alternative embodiments, the first high-side compressor 340 can include or be provided as a variable speed compressor and the second high-side compressor 350 can include or be provided as a fixed speed compressor.

During operations of the refrigeration system 301 of FIGS. 3 and 4 and FIG. 5, the upper level of the oil in each of the oil sumps 348 and 358 needs to be high enough to lubricate rotating components of at least the compressor sections 343 and 353 and it is often the case that some of the oil from each of the oil sumps 348 and 358 is carried out into other components and then not returned to the oil sumps 348 and 358 evenly. As explained above, such imbalanced oil return requires that the refrigeration system 301 be able to balance oil between the oil sumps 348 and 358 and this requires a minimal gas pressure difference between the first and second high-side compressors 340 and 350.

Therefore, the first pipe 360 is connected to the respective shells 341 and 351 of the first and second high-side compressors 340 and 350 below vertical heights H1 and H2, which are measured from respective bottoms of the first and second high-side compressors 340 and 350, at which oil supplies in each of the oil sumps 348 and 358 are required to remain higher. The first pipe 360 thus allows oil to pass between the oil sumps 348 and 358 in the shells 341 and 351 of each of the first and second high-side compressors 340 and 350. The first pipe 360 can include valve 361 (see FIG. 4), which is used to close the first pipe 360.

The second pipe 370 is connected to the respective shells 341 and 351 of the first and second high-side compressors 340 and 350 at vertical heights that are sufficient to maintain gas pressure balance between the first and second high-side compressors 340 and 350. The second pipe 370 is positioned above the respective motors 344 and 354 and is located opposite the flow paths 347 and 357 to limit gas velocity entering the second pipe 370. The second pipe 370 can include valve 371 (see FIG. 4), which is used to close the second pipe 370.

Valve 361 is included to enable solo operation of the first and second high-side compressors 340 and 350. When only the first high-side compressor 340 or the second high-side compressor 350 is operating with pipes 360 and 370 open, discharge gas flows through the second pipe 370 to the common discharge line 310. This creates a gas pressure differential between shells 341 and 351, which pushes oil from the operating compressor to the non-operating compressor through the first pipe 360. Valve 361 closes the first pipe 360 to stop oil flow in this condition.

Additionally, shells 341 and 351 are designed to capture some of the oil carried by the discharge gas from sump 348 or 358 before it enters the refrigeration system 301 via discharge pipe 321 or 322. This is advantageous in tandem operation because it reduces the amount of oil carried into the refrigeration system 301. During solo operation however, discharge gas can flow into the other compressor shell through the second pipe 370. Under this condition, the running compressor would log oil in the opposite sump because the opposite shell would separate and capture the oil carried from the running compressor. Valve 371 closes the second pipe 370 to stop oil and gas flow in this condition.

With reference to FIG. 6, a refrigeration system 501 is provided and includes a common suction line 510, including a first leg 511 and a second leg 512, a common discharge line 520, including a first leg 521 and a second leg 522, a first high-side compressor 540 and a second high-side compressor 550. The first and second high-side compressors 540 and 550 are constructed similarly as the first and second high-side compressors 340 and 350 of FIGS. 3 and 4 and of FIG. 5 and are disposed in parallel with one another to receive low-pressure refrigerant from the first and second legs 511 and 512 of the common suction line 510, respectively, and to direct high-pressure refrigerant to the first and second legs 521 and 522 of the common discharge line 520.

The refrigeration system 501 can further include an evaporator 502 from which the common suction line 510 carries the low-pressure refrigerant to the first and second high-side compressors 540 and 550, a condenser 503, which is receptive of the high-pressure refrigerant from the first and second high-side compressors 540 and 550 by way of the common discharge line 520, and an expansion valve 504 that is fluidly interposed between the condenser 503 and the evaporator 502.

In accordance with embodiments, the first high-side compressor 540 can include or be provided as a fixed speed compressor and the second high-side compressor 550 can include or be provided as a variable speed compressor. In accordance with alternative embodiments, the first high-side compressor 540 can include or be provided as a variable speed compressor and the second high-side compressor 550 can include or be provided as a fixed speed compressor.

Within the spirit of the present invention, the following embodiments are also presented.

In the configuration where both the first and second high-side compressors 540 and 550 are fixed speed, the total refrigeration capacity of the system 501 is met by both compressors operating together. The first fixed speed high-side compressor provides X % of the total system capacity, while the other fixed speed high-side compressor provides Y % of the total system capacity. X % and Y % can be the same proportion of the total system capacity, or a different proportion of the total system capacity. When combined, this tandem can provide 3 stages of cooling capacity, depending on whether 1 or both compressors are operating.

In the configuration where one of the first and second high-side compressors 540 and 550 is fixed speed while the other is variable speed, the total refrigeration system capacity requirement of the refrigeration system 501 is met by the fixed speed high-side compressor and the maximum chosen rotational speed of the variable speed high-side compressor. The fixed speed high-side compressor provides X % of the total refrigerant system capacity requirement, while the variable speed high-side compressor provides capacity modulation from 1% to Y % of the total refrigeration system capacity requirement, where Y % is the proportion of the total refrigeration system capacity requirement provided by the variable speed high-side compressor at maximum rotational speed. When combined, this tandem provides capacity modulation from 1% to 100% of the total refrigeration system capacity requirement, depending on whether both high-side compressors are operating, or just the variable speed high-side compressor.

In the configuration where both the first and second high-side compressors 540 and 550 are variable speed, the total refrigeration system capacity of the refrigeration system 501 is met by the maximum chosen rotational speed of both variable speed high-side compressors. The first variable speed high-side compressor provides capacity modulation from 1% to X % of the total system capacity, while the second variable speed high-side compressor provides capacity modulation from 1% to Y % of the total system capacity, where X % and Y % are the proportion of the total system capacity provided by each variable speed high-side compressor at the chosen maximum rotational speed. X % and Y % can be the same proportion of total system capacity, or different proportions of total system capacity. When combined, this tandem provides capacity modulation from 1% to 100% of the total refrigeration system capacity requirement, depending on whether 1 or both compressors are operating.

In accordance with still further embodiments, the refrigeration system 501 can also include first and second pipes similar to the first and second pipes 360 and 370 of FIG. 2.

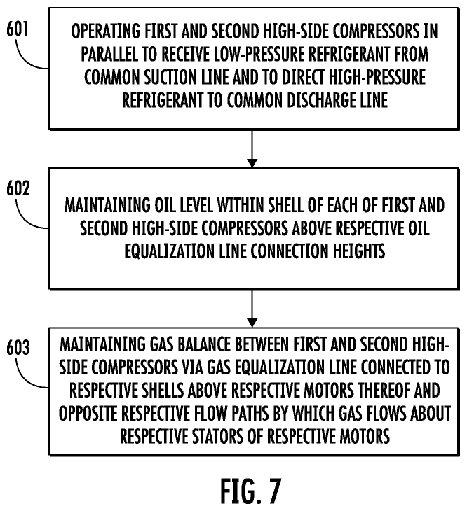

With reference to FIG. 7, a method of operating a refrigeration system, such as the refrigeration system 301 of FIGS. 3 and 4 and the refrigeration system 501 of FIG. 6 is shown. As shown in FIG. 7, the method includes operating first and second high-side compressors in parallel to receive low-pressure refrigerant from the common suction line and to direct high-pressure refrigerant to the common discharge line (601), maintaining an oil level within a shell of each of the first and second high-side compressors above respective oil equalization line connection heights (602) and maintaining a gas balance between the first and second high-side compressors via a gas equalization line connected to the respective shells above respective motors thereof and opposite respective flow paths by which gas flows about respective stators of the respective motors (603). In accordance with embodiments, the maintaining of the gas balance between the first and second high-side compressors of operation 603 can include maintaining the gas balance to be less than 0.1 psi.

As above, the first high-side compressor can include or be provided a fixed speed compressor and the second high-side compressor can include or be provided as a variable speed compressor (or vice versa).

Technical effects and benefits of the present disclosure are the provision of an HVAC system that provides increased efficiency while significantly reducing costs. Also, in the case of a compressor failure, the HVAC system provides for a second compressor that will still operate and provide cooling/heating.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A refrigeration system, comprising:
a common suction line;
a common discharge line;
first and second high-side compressors disposed in parallel to receive low-pressure refrigerant from the common suction line and to direct high-pressure refrigerant to the common discharge line;
a first pipe connected to the first and second high-side compressors at vertical heights at which an oil supply is required to remain higher; and
a second pipe connected to the first and second high-side compressors at vertical heights sufficient to maintain gas pressure balance between the first and second high-side compressors.

2. The refrigeration system according to claim 1, further comprising:
an evaporator from which the common suction line carries the low-pressure refrigerant;
a condenser to which the common discharge line carries the high-pressure refrigerant; and
an expansion valve fluidly interposed between the condenser and the evaporator.

3. The refrigeration system according to claim 1, wherein the first pipe includes a valve and the second pipe includes a valve.

4. The refrigeration system according to claim 1, wherein each of the first and second high-side compressors comprises:
a shell to define an interior;
a compressor section disposed within the interior to compress the low-pressure refrigerant; and
a motor disposed within the interior at a location, which is closer to the common discharge line than the common suction line, to drive operations of the compressor section.

5. The refrigeration system according to claim 4, wherein the first pipe allows oil to pass between the shell of each of the first and second high-side compressors.

6. The refrigeration system according to claim 4, wherein the motor comprises a stator and the shell defines a flow path by which gas flows about the stator for each of the first and second high-side compressors.

7. The refrigeration system according to claim 6, wherein the second pipe is connected to the shell of each of the first and second high-side compressors above the motor and opposite the flow path.

8. The refrigeration system according to claim 4, wherein the second pipe is positioned to minimize a shell pressure difference between the first and second high-side compressors.

9. A refrigeration system, comprising:
a common suction line;
a common discharge line; and
first and second high-side compressors disposed in parallel to receive low-pressure refrigerant from the common suction line and to direct high-pressure refrigerant to the common discharge line,
the first high-side compressor comprising a fixed speed compressor, and
the second high-side compressor comprising a variable speed compressor.

10. The refrigeration system according to claim 9, further comprising:
an evaporator from which the common suction line carries the low-pressure refrigerant;
a condenser to which the common discharge line carries the high-pressure refrigerant; and
an expansion valve fluidly interposed between the condenser and the evaporator.

11. The refrigeration system according to claim 9, wherein:
the variable speed compressor has a capacity of a percentage of a total refrigeration system capacity requirement, and
the fixed speed compressor has a capacity of a remainder of the total refrigeration system capacity requirement.

12. The refrigeration system according to claim 9, wherein each of the first and second high-side compressors comprises:
a shell to define an interior;
a compressor section disposed within the interior to compress the low-pressure refrigerant; and
a motor disposed within the interior at a location, which is closer to the common discharge line than the common suction line, to drive operations of the compressor section.

13. The refrigeration system according to claim 9, further comprising:
a first pipe connected to the first and second high-side compressors at vertical heights at which an oil supply is required to remain higher; and
a second pipe connected to the first and second high-side compressors at vertical heights sufficient to maintain gas pressure balance between the first and second high-side compressors.

14. The refrigeration system according to claim 13, wherein the first pipe includes a valve and the second pipe includes a valve.

15. The refrigeration system according to claim 13, wherein the first pipe allows oil to pass between a shell of each of the first and second high-side compressors.

16. The refrigeration system according to claim 13, wherein a motor drives a compressor section and comprises a stator and a shell defines a flow path by which gas flows about the stator for each of the first and second high-side compressors.

17. The refrigeration system according to claim 16, wherein the second pipe is connected to the shell of each of the first and second high-side compressors above the motor and opposite the flow path.

18. The refrigeration system according to claim 13, wherein the second pipe is positioned to minimize a shell pressure difference between the first and second high-side compressors.

19. A method of operating a refrigeration system, the method comprising:
operating first and second high-side compressors in parallel to receive low-pressure refrigerant from the common suction line and to direct high-pressure refrigerant to the common discharge line;
maintaining an oil level within a shell of each of the first and second high-side compressors above respective oil equalization line connection heights; and
maintaining a gas balance between the first and second high-side compressors via a gas equalization line connected to the respective shells above respective motors thereof and opposite respective flow paths by which gas flows about respective stators of the respective motors.

20. The method according to claim 19, wherein:
the first high-side compressor comprises a fixed speed compressor and the second high-side compressor comprises a variable speed compressor,
the variable speed compressor has a capacity of a percentage of a total refrigeration system capacity requirement, and
the fixed speed compressor has a capacity of a rest of the total refrigeration system capacity requirement.
